(19) United States
(12) Patent Application Publication
(10) Pub. No.: US 2015/0104727 A1
(43) Pub. Date: Apr. 16, 2015

(54) METHOD OF FORMING A FUEL CELL SHEET

(71) Applicant: Ballard Power Systems Inc., Burnaby (CA)

(72) Inventors: Jean Yamanis, South Glastonbury, CT (US); Mark R. Jaworowski, Glastonbury, CT (US)

(21) Appl. No.: 14/310,597

(22) Filed: Jun. 20, 2014

Related U.S. Application Data
(63) Continuation of application No. 13/128,728, filed on May 11, 2011, now abandoned.

(51) Int. Cl. H01M 8/02

(52) U.S. Cl. CPC H01M 8/0232; H01M 2008/1293
USPC 429/457; 429/535

(57) ABSTRACT

An example method of forming a fuel cell sheet includes flattening a screen to form a sheet that has a plurality of apertures operative to communicate a fluid within a fuel cell.

### STATEMENT REGARDING FEDERALLY SPONSORED RESEARCH

This invention was made with United States Government support under contract NNC06CA45C awarded by the National Aeronautics and Space Administration. The United States Government may have certain rights in this invention.

### TECHNICAL FIELD

This disclosure relates generally to fuel cells and, more particularly, to a porous sheet for a fuel cell.

### DESCRIPTION OF RELATED ART

Fuel cell assemblies are well known. One type of fuel cell is a solid oxide fuel cell (SOFC). Known SOFCs include a tri-layer cell having an electrolyte layer positioned between a cathode electrode layer and an anode electrode layer. An interconnector near the anode electrode layer and another interconnector near the cathode electrode layer facilitate electrically connecting the cell to an adjacent cell within a fuel cell stack.

Fluids, such a fuel and oxidant, often communicate within the fuel cell through holes in porous sheets. For example, some SOFCs include supportive porous sheets between the anode interconnector and the anode electrode layer. Fuel flows between the anode electrode later and the anode interconnector through the sheet. International Publication No. WO2007/044045 to Yamanis, the contents of which are incorporated herein by reference, describes one such supportive porous sheet.

One example porous sheet is 20-30% porous and includes multiple 10 micrometer diameter holes. Other example fuel cells utilize porous sheets with different porosities and hole diameters. As known, manufacturing porous sheets is often difficult. Drilling and punching operations can create individual holes, but required clearances for drilling and punching tools hamper machining multiple, closely positioned holes. These operations are also costly. Fabricating the porous sheets using powder metallurgy processes can enable closely positioning the holes, but often results in thick and heavy porous sheets that are often cumbersome to incorporate within the SOFC.

### SUMMARY

An example method of forming a fuel cell sheet includes flattening a screen to form a sheet that has a plurality of apertures operative to communicate a fluid within a fuel cell. In one example, the sheet is a porous fuel cell supporting sheet that communicates fluid to a fuel cell electrode.

An example fuel cell stack assembly includes a cell and a supporting sheet formed from a flattened screen. The sheet includes a plurality of apertures configured to allow passage of a fuel cell fluid through the sheet. The sheet is a supporting sheet in one example.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1A shows a schematic view a fuel cell stack assembly.

FIG. 1B shows a schematic view of a solid oxide fuel cell within the FIG. 1A assembly.

FIG. 2A shows an example screen.

FIG. 2B shows an end view of the FIG. 2A screen.

FIG. 3 shows an example sheet formed from the FIG. 2A and 2B screen.

FIG. 4A shows a top view of the porous sheet from FIG. 3.

FIG. 4B shows an edge view of the porous sheet from FIG. 3

FIG. 5 shows a sectional view of the FIG. 3A sheet within a portion of the fuel cell.

### DETAILED DESCRIPTION

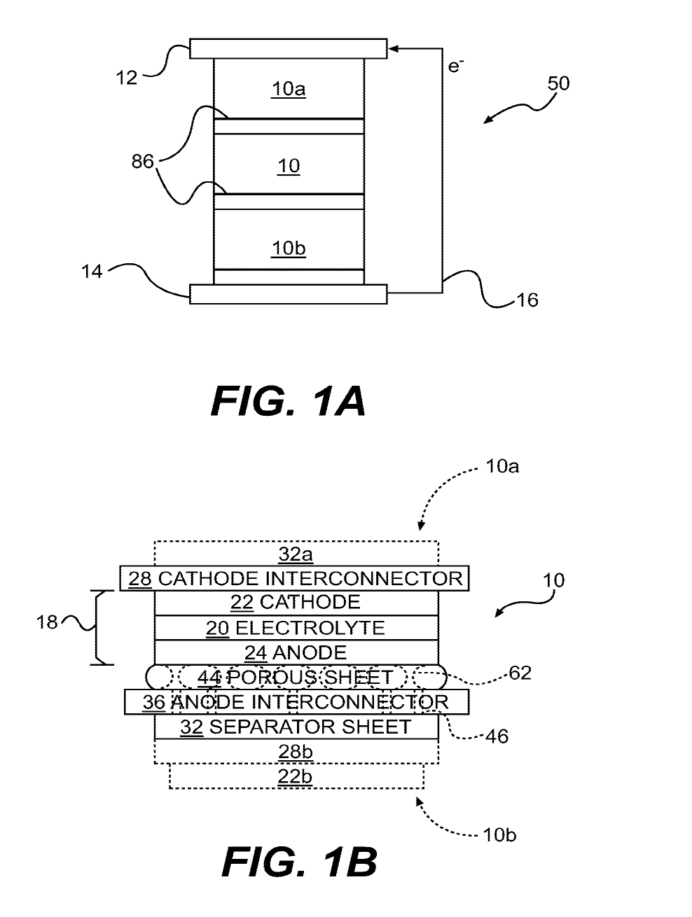

Referring to FIGS. 1A and 1B, an example thick-film solid oxide fuel cell assembly (SOFC) 10 is positioned within a fuel cell stack assembly 50 between a SOFC 10a and a SOFC 10b. A first metal plate 12 and a second metal plate 14 are secured at opposing ends of the fuel cell stack assembly 50. Electrons travel from the SOFC 10a, to the SOFC 10, to the SOFC 10b and to the second metal plate 14 to provide electric power from the fuel cell stack assembly 50 along path 16 in a known manner.

The example thick-film solid oxide fuel cell assembly (SOFC) 10 includes a tri-layer cell portion 18, a type of cell, having an electrolyte layer 20 positioned between a cathode electrode layer 22 and an anode electrode layer 24. The cathode electrode layer 22 is mounted adjacent a cathode interconnector 28, which abuts a separator sheet 32a of the SOFC 10a. A separator sheet 32 of the SOFC 10 separates fuel fluid in an anode interconnector 36 from an oxidant fluid in a cathode interconnector 28b of the SOFC 10b.

A porous sheet 44 separates the anode electrode layer 24 of the tri-layer cell portion 18 from the anode interconnector 36. Fuel, a type of fluid comprised of hydrogen or mixtures of hydrogen, carbon monoxide, and other gases, moves between the fluid channel corresponding to the anode interconnector 36 and the anode electrode layer 24 through a plurality of apertures in the porous sheet 44. In this example, the porous sheet 44 also supports the tri-layer cell portion 18. Open spaces, or fluid channels, between the porous sheet 44 and the separator sheet 32 are available for fluid flow. These open spaces are also known as the anode interconnect channels 46.

The porous sheet 44 in this example is incorporated within the SOFC 10 that has the fuel fluid contained by reliably sealed boundaries. In another example, however, the porous sheet 44 could serve as the support for the cathode electrode 22 or the electrolyte layer 20.

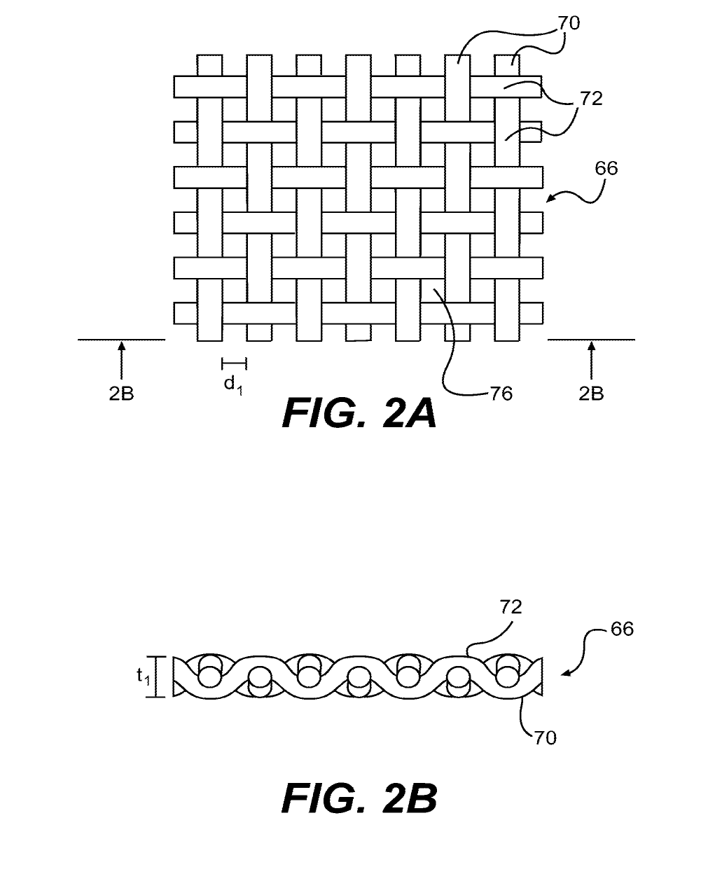

Referring now to example of FIGS. 2A and 2B, a plurality of first wires 70 woven with a plurality of second wires 72 form an example screen 66. In one example, the first plurality of wires 70 and the second plurality of wires 72 are metal wires, such as nickel wires or nickel-based alloy wires or stainless steel wires, drawn to diameters of about 25 micrometers or greater, and the wires 70, 72 have a generally circular cross-section.

The screen 66 includes a plurality of openings 76 each having a generally rectangular geometry. The example screen 66 is a 400 mesh plain weave. That is, the example screen includes 400 wires per inch (about 180 wires per centimeter). Other example weave patterns include square, twill, Dutch, twill-Dutch, etc. As known, altering the diameter of the wires 70, 72, modifying the weave pattern of the screen 66, or both can change the profile of the openings 76.

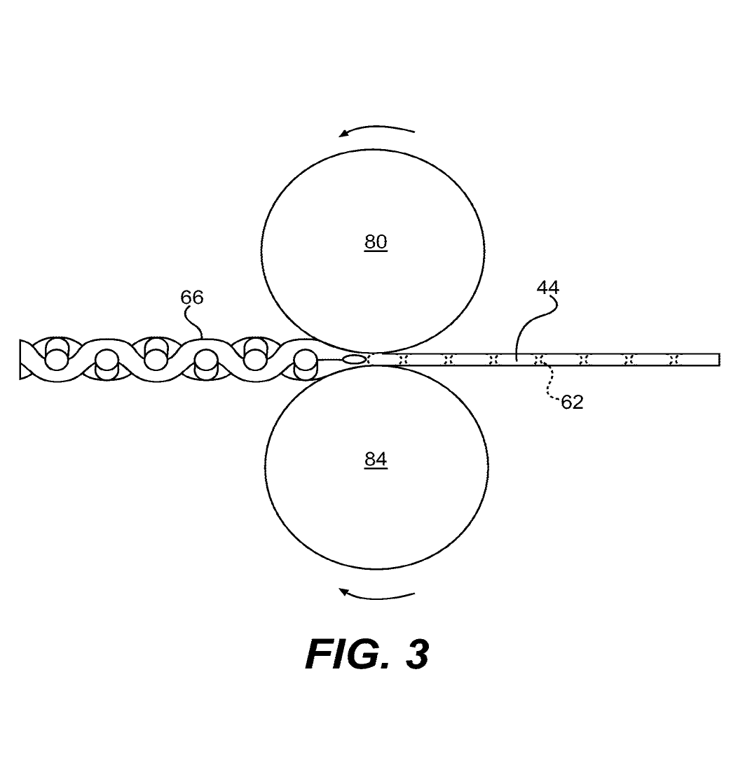

Referring to FIG. 3, a first roller 80 and a second roller 84 rotate in opposite directions. The rollers 80, 84 are spaced such that they compress the screen 66 and flatten it as it is fed between the rollers 80, 84. Flattening the screen 66 forms the porous sheet 44 by moving material to reduce the open area of the screen 66. The screen 66 has a higher porosity than the porous sheet 44 because of the reduced open area. Other examples suitable for flattening the screen 66 include rolling the screen 66 and the porous sheet 44 multiple times with or without intermediate heat treatments to anneal cold work stresses, stamping the screen 66, etc. Temperature, exposure time, and atmosphere for the intermediate heat treatments depend on the type and size of the wires 70, 72 in some examples.

The rollers 80, 84 exert pressure on the wires, 70, 72, which plastically deforms the wires 70, 72 and cold welds the wires 70, 72 together to form the porous sheet 44. Accordingly, the porous sheet 44 is substantially monolithic. As known, ductile materials, such as those comprising the wires 70, 72 are especially suited for such plastic deformation. In this example, the wires 70, 72 are metal wires, thus, the porous sheet 44 is also metal.

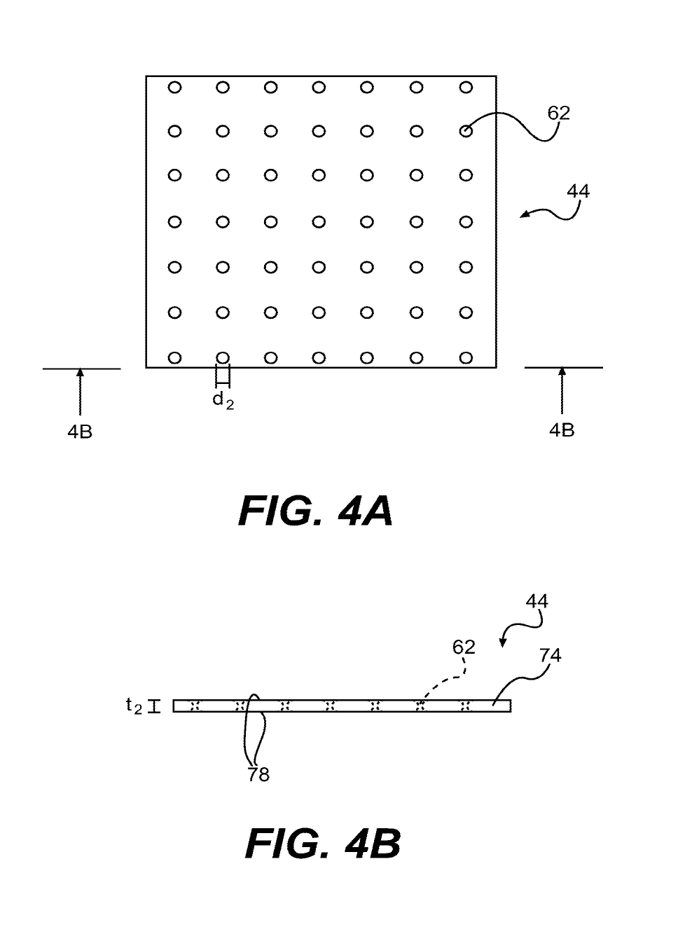

Referring now to FIGS. 4A and 4B with continuing reference to FIGS. 2A and 2B, the flattening reduces the thickness t1 of the screen 66 to the thickness t2 of the porous sheet 44. The apertures 62 in the porous sheet 44 have a smaller diameter d2 than the diameter d1 of the openings 76 in the screen 66 due to the material movement during the flattening. In this example, the apertures 62 are wider near a surface 78 of the porous sheet 44 due to the flattening operation. As can be appreciated from FIG. 4B, the apertures 62 have a somewhat “hour glass” shape.

A person skilled in the art and having the benefit of this disclosure would be able to adjust parameters (such as the size of the openings 76 in the screen, weave patterns, thickness t1, etc.) to produce a desired diameter d2 . . . In one example, the diameter d2 is 10 micrometers or less. Opening 62 can be tailored to have a diameter that can be bridged by sinter-reactive ceramic powders, metal powders and mixtures thereof, during the process of depositing the anode electrode layer 24 of the fuel cell assembly 10 shown in FIG. 1B while keeping the resistance to fuel flow through the opening 62 substantially unaffected.

Referring again to FIG. 1A, in this example, the porous sheet 44 is used as a support structure within the SOFC 10. In some examples, strengthening the porous sheet 44 for such a supportive use includes bonding, such as by diffusion bonding, brazing or welding, the porous sheet 44 to an expanded metal sheet 86 to further strengthen the porous sheet 44.

Although the porous sheet 44 is generally described as suitable for use as a support within the SOFC 10 and for communicating fluid between the anode interconnector 36 and, the anode electrode layer 24, other areas of the SOFC 10 and other types of fuel cells would benefit from such a sheet.

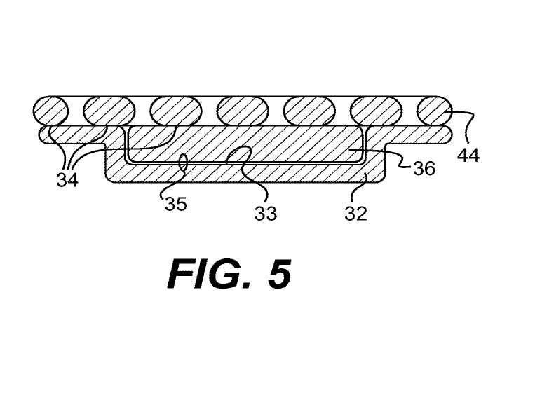

Referring now to FIG. 5, the example porous sheet 44 and separator sheet 32 are sealed at their periphery, which encloses the anode interconnector 36 and prevents the fuel and oxidant fluids from freely mixing at their periphery. Sealing thus facilitates limiting wasteful and potentially destructive fuel combustion.

In this example, the separator sheet 32 is shaped into a shallow dish 33 of a desired geometry. Other examples include other shapes, such as rectangular, square, circular and the like. The dish 33 is of sufficient depth to accommodate the anode interconnector 36 in this example. The stamped separator sheet 33, the anode interconnector 36, and the porous sheet 44 are assembled and bonded at 34 both at the periphery as well as at the interfaces between the anode interconnector 36 and the porous sheet 44, and also bonded at 35 between the anode interconnector 36 and the stamped sheet 33. Bonds 34 and 35 could be effected by means of welding, brazing, diffusion bonding or any combination thereof.

Features of the disclosed example include a lightweight porous sheet having a desired porosity that is manufactured from a woven screen.

Although a preferred embodiment has been disclosed, a worker of ordinary skill in this art may recognize that certain modifications are possible and come within the scope of this disclosure. For that reason, the following claims should be studied to determine the true scope of legal protection coverage.

1. A method, comprising:
forming a porous fuel cell sheet, the porous fuel cell sheet having a first thickness, the forming including:
compressing a sheet of a plurality woven wires to have the first thickness, the sheet having a plurality of openings, prior to the compressing the sheet has a second thickness that is greater than the first thickness, the compressing including:
changing a diameter of the plurality of openings to a smaller diameter configured to communicate a fluid within a fuel cell.

2. The method of claim 1, wherein the plurality of openings each have an hour-glass shape after the compressing.

3. The method of claim 2, wherein the compressing includes a first wire of the sheet to a second wire of the sheet.

4. The method of claim 2, wherein the compressing includes cold welding a first wire of the sheet to a second wire of the sheet.

5. The method of claim 1, including weaving a plurality of wires to form the sheet.

6. The method of claim 5, wherein the plurality of wires comprise metal wires.

7. The method of claim 5, wherein the plurality of wires have a generally circular cross-section.

8. The method of claim 1, wherein the sheet plurality of openings change from a generally rectangular shape to a generally circular shape with the compressing.

9. The method of claim 1, wherein the sheet has a lower porosity after the compressing.

10. The method of claim 1, wherein the compressing includes rolling the sheet between a first and a second roller.

11. The method of claim 1, wherein the sheet is operative to support a cell.

12. The method of claim 1, wherein the plurality of openings are operative to communicate the fluid between an interconnector and a cell.

13. The method of claim 1, wherein the compressing comprises multiple rolling and compression steps.

14. The method of claim 1, wherein the compressing comprises multiple rolling and compression steps with intermediate annealing steps.

15. The method of claim 1, wherein the compressing is performed using no more than a single woven layer of the plurality of wires to form the sheet.

16. (canceled)

17. The method of claim 1, wherein the sheet is a wire sheet comprising a first plurality of wires arranged parallel to each other and a second plurality of wires arranged parallel to each other, the first plurality of wires perpendicular to the second plurality of wires.

18-22. (canceled)

23. A device, comprising:
a fuel cell stack including:
a porous sheet having a first surface that is opposite to a second surface and a central region between the first and second surfaces, the porous sheet includes:
a plurality of openings, the plurality of openings being configured to move a fluid through the porous sheet, the plurality of openings being wider at the first and second surfaces than at the central region; and
a plurality of woven wires being compressed together to define the plurality of openings.

24. The device of claim 23, wherein the plurality of openings having an hour-glass shape.

25. The device of claim 23, wherein the fuel cell stack includes an anode electrode layer and an anode interconnector, the porous sheet being between the anode cathode layer and the anode interconnector.

26. The device of claim 23 wherein the plurality of woven wires are a nickel based alloy and are cold welded together.
